(19) United States
(12) Patent Application Publication
(10) Pub. No.: US 2011/0179924 A1
(43) Pub. Date: Jul. 28, 2011

(54) Bench Cutting Machine

(75) Inventors: Hirohisa Tomita, Ibaraki (JP); Shigehuru Ushiwata, Ibaraki (JP)

(73) Assignee: Hitachi Koki Co., Ltd., Minato-ku, Tokyo (JP)

(21) Appl. No.: 13/121,172

(22) PCT Filed: Sep. 15, 2009
(86) PCT No.: PCT/JP2009/066571

§ 371 Date: Mar. 25, 2011

(30) Foreign Application Priority Data
Sep. 30, 2008 (JP) 2008-253617

(51) Int. Cl. B26D 7/10

(52) U.S. Cl. 83/170

(57) ABSTRACT

According to an aspect of the present invention, there is provided a bench cutting machine including: a motor that drives a cutting blade; a fan that is driven by the motor to generate a fan air; a base portion; a cutting portion that accommodates the cutting blade over the base portion; and a supporting portion that movably supports the cutting portion, wherein rotational directions of the fan and the cutting blade are arranged to be the same.

### TECHNICAL FIELD

An aspect of the present invention relates to a bench cutting machine, and particularly to a bench cutting machine including a mechanism which discharges dusts.

### BACKGROUND ART

In a conventional bench cutting machine as shown in JP-H11-170214-A, the dusts when a work piece is cut by a rotationally-driven cutting blade are guided to a dust guide passage by the inertial force and the airflow generated by the cutting blade, and the dusts are collected in a garbage collection bag outside the bench cutting machine from the dust guide passage.

In the bench cutting machine shown in JP-H11-170214-A, a rotary shaft of a motor is provided with a fan, and the motor is cooled by the fan air generated by the fan. Since the rotational direction of the motor and the rotational direction of the cutting blade are opposite directions, a vortex of the fan air generated by the fan is canceled by the airflow generated by the rotated cutting blade. In the above-described bench cutting machine, the dusts are discharged to the outside of the machine by the airflow generated by the cutting blade. In this case, when the fan air is discharged to the dust guide passage case, the guide efficiency of the dusts may be lowered.

### SUMMARY OF INVENTION

One of the objects of the invention is to provide a bench cutting machine which more suitably discharges the dusts to the outside during cutting.

According to an aspect of the present invention, there is provided a bench cutting machine including: a motor that drives a cutting blade; a fan that is driven by the motor to generate a fan air for cooling the motor; a base portion that supports a member to be worked; a cutting portion that is provided on the base portion and that accommodates the cutting blade over the base portion; and a supporting portion that is connected to the base portion and that supports the cutting portion so that a position of the cutting blade with respect to the base portion is adjustable, wherein the motor is arranged on the lateral side of the cutting blade, wherein the cutting portion includes: a housing that houses the motor, the fan and a portion of the cutting blade; and a transmission mechanism that is housed within the housing and that transmits a power of the motor to the cutting blade, wherein the transmission mechanism is configured so that a rotational direction of the fan and a rotational direction of the cutting blade become the same, and wherein the housing includes: a motor housing portion that houses the motor; a cutting blade housing portion that houses the portion of the cutting blade; a dust discharge port that communicates the cutting blade housing portion with an outside thereof; and a passage that communicates the motor housing portion with the cutting blade housing portion so as to allow the fan air to flow into the cutting blade housing portion.

According to such a configuration, since the rotational directions of the fan and the cutting blade are aligned, the direction of a vortex of the fan air generated by the fan becomes the same direction as the rotational direction of the cutting blade. Therefore, when this fan air is made to flow into the cutting blade housing portion from the introduction passage, the fan air can be kept from disturbing the flow of the airflow caused by the rotation of the cutting blade, and the vigor of the airflow can be strengthened by the downstream of the fan air. Therefore, the guide efficiency of the dusts which are guided and discharged to the dust discharge port by the airflow can be enhanced, and the dusts can be suitably discharged from the dust discharge port.

The fan may be directly driven by the motor. And, the transmission mechanism may include: a first gear that is directly driven by the motor; a final gear that rotates coaxially and integrally with the cutting blade; and an intermediate gear that meshes with the first gear and the final gear and that transmits a rotation of the first gear to the final gear.

The intermediate gear may transmit the rotation of the first gear to the final gear while decelerating.

According to such a configuration, the rotational directions of the fan and the cutting blade can be aligned with a simple configuration.

The fan may be a centrifugal fan.

According to such a configuration, a vortex can be more suitably formed.

A rotary shaft of the motor may be arranged parallel to a rotary shaft of the cutting blade.

According to such a configuration, the vigor of the airflow of a cutting blade can be most suitably strengthened by the vortex.

A rotary shaft of the motor may be arranged oblique to a rotary shaft of the cutting blade.

A plurality of ribs may be formed within the passage in the housing.

In a cross-sectional plane orthogonal to a rotary shaft of the cutting blade, each rib may radially extend from the rotary shaft of the cutting blade.

According to such a configuration, the portion of the housing in which the introduction passage is formed can be reinforced, and the fan air which flows through the inside of the introduction passage can be corrected.

An air intake port is formed on the motor housing portion at a side opposite to the cutting blade housing portion.

### BRIEF DESCRIPTION OF DRAWINGS

FIG. 1 is a side view of a bench cutting machine according to an embodiment of the invention.

FIG. 2 is a front view of the bench cutting machine according to the embodiment.

FIG. 3 is a sectional view of a cutting portion of the bench cutting machine according to the embodiment.

FIG. 4 is a sectional view taken along the line IV-IV of FIG. 3.

FIG. 5 is a sectional view taken along the line V-V of FIG. 3.

FIG. 6 is a sectional view of a gear case of the bench cutting machine according to the embodiment.

FIG. 7 is a view showing a cutting state of the bench cutting machine according to the embodiment (a state before cutting).

FIG. 8 is a view showing a cutting state of the bench cutting machine according to the embodiment (a state during cutting).

FIG. 9 is a conceptual view showing the relationship between a vortex and an airflow of the bench cutting machine according to the embodiment.

FIG. 10 is a view showing a cutting state of the bench cutting machine according to the embodiment (a cutting completion state).

FIG. 11 is a side view of the bench cutting machine according to a modification of the embodiment.

FIG. 12 is a sectional view of a cutting portion of the bench cutting machine according to a modification of the embodiment.

### DESCRIPTION OF EMBODIMENTS

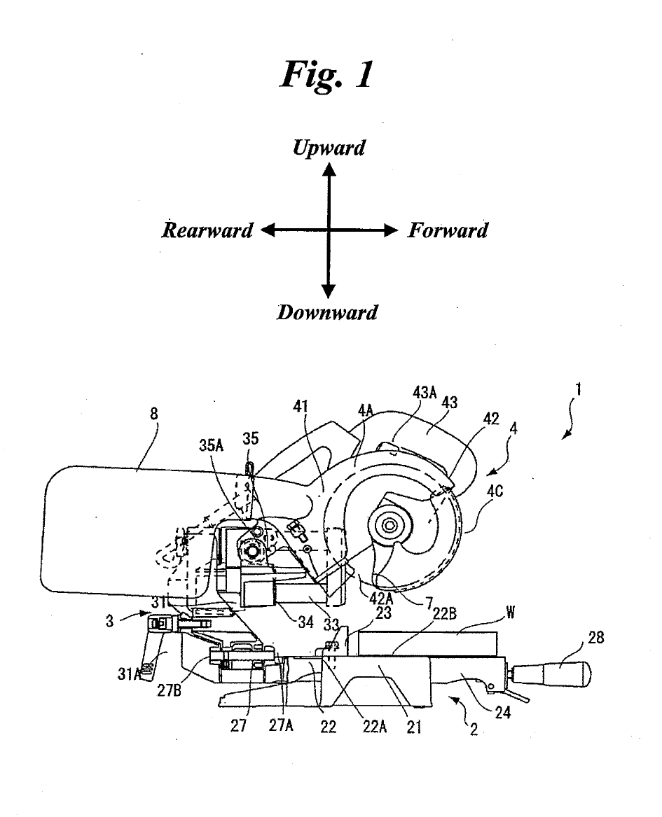

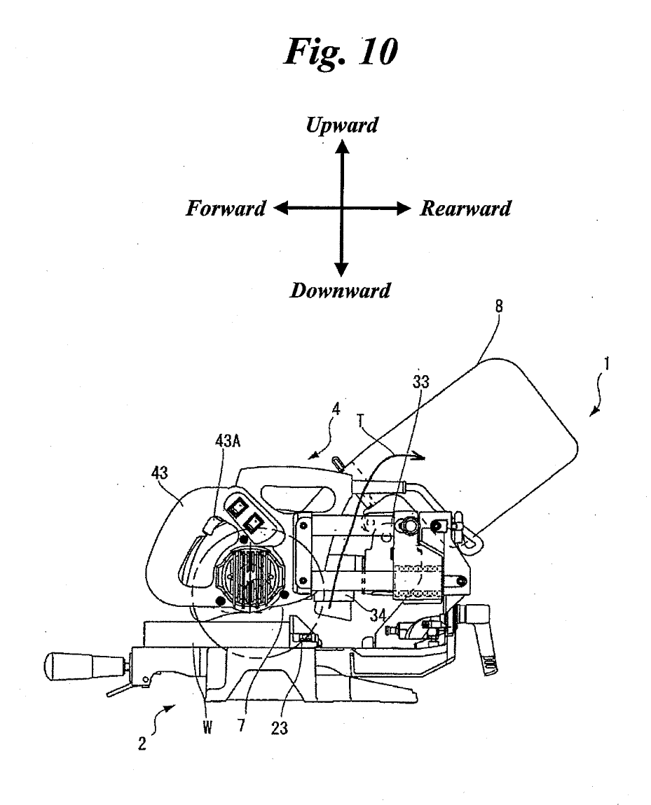

Hereinafter, a bench cutting machine according to an embodiment of the invention is described with reference to FIGS. 1 to 10. A bench cutting machine 1 that is a bench cutting machine shown in FIG. 1 is a bench cutting machine including a sliding mechanism, and mainly includes a base portion 2, a supporting portion 3, a cutting portion 4, and a cutting blade 7.

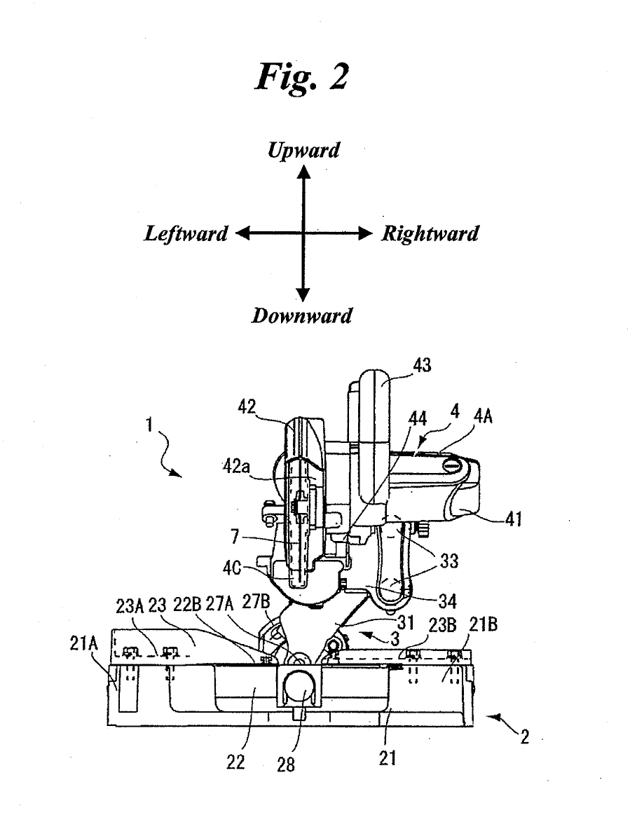

The base portion 2 mainly includes a base 21 which carries timber W that is a member to be cut, a turntable 22 rotatably carried on the base 21, and a fence 23 provided at the base 21. The base 21, as shown in FIG. 2, includes a pair of a left base 21A and a right base 21B. The direction in which the left base 21A and the right base 21B are aligned is defined as a right-left direction, the upside of the surface of the base 21 (FIG. 1) on which the timber W is placed defined as the upside, and the side opposite to the upside is defined as the downside.

As shown in FIG. 2, the turntable 22 is arranged between the right base 21B and the left base 21A. As shown in FIG. 1, the turntable 22 includes a substantially truncated conical turntable body portion 22A, a protruding portion 24 which protrudes towards one side of the turntable body portion 22A, and a cutting portion supporting portion 27 which supports a supporting portion 3 which is provided on the other side of the protruding portion 24 and which will be described later. The direction in which the protruding portion 24 protrudes from the turntable, and which intersects the right-left direction is defined as the front, and the side opposite to the front is defined as the rear.

Additionally, a series of grooves (not shown) are formed from a position near the cutting portion supporting portion 27 to the protruding portion 24 in an upper surface 22B of the turntable 22. The grooves (not shown) serve as parts which house the blade edge of the cutting blade 7 in the same position as the line of intersection when the cutting blade 7 rocks downward, and intersects the turntable 22.

As shown in FIGS. 1 and 2, the protruding portion 24 is provided with a regulation operating portion 28 used as an operating portion when the rotation of the turntable 22 with respect to the base 21 is regulated. As shown in FIG. 1, the cutting portion supporting portion 27 is arranged in the position opposite to the protruding portion 24 with respect to the central axis of the turntable 22. The cutting portion supporting portion 27 has a tilt shaft 27A located on an extension line of the grooves (not shown) , and a tilt supporting portion 27B to which the supporting portion 3 is fixed at an arbitrary inclination angle.

As shown in FIG. 1, the fence 23 is provided in the position above the turntable 22 on the base 21. As shown in FIG. 2, the fence 23 includes a left fence 23A and a right fence 23B corresponding to the left base 21A and the right base 21B, the front faces of the left fence 23A and the right fence 23B are arranged so as to be located on the same plane, thereby specifying the position of the timber W (FIG. 1).

As shown in FIG. 1, the supporting portion 3 mainly includes a tilting portion 31, sliding pipes 33, a sliding portion 34, and a rocking portion 35. The tilting portion 31 is supported by the tilt shaft 27A, and is configured so as to be able to be fixed to the tilt supporting portion 27B by a clamp 31A. By loosening the clamp 31A, the tilting portion 31 and the cutting portion 4 connected to the tilting portion 31 can be tilted with respect to the base portion 2, and by fastening the clamp 31A, the tilting portion 31 is fixed to the cutting portion supporting portion 27B, and the cutting portion 4 maintains a predetermined tilting angle with respect to the base portion 2. The sliding pipes 33 are constituted by two tubular bodies and are fixed to the tilting portion, and as shown in FIG. 2, the two tubular bodies are arranged in parallel in an up-down direction, and extend from an upper portion of the tilting portion 31 parallel to the upper surface of the base portion 2. The sliding portion 34 is mounted on the sliding pipes 33, and is configured so as to be slidable back and forth with respect to the sliding pipes 33. The rocking portion 35 is provided at the sliding portion 34, and is constituted by a pair of arm portions. A rocking shaft portion 35A is laid between a pair of arm portions, and the cutting portion 4 is supported by the rocking shaft portions 35A so that the cutting blade 7 is brought close to or separated from the upper surface of the turntable 22. Therefore, the cutting portion 4 can reciprocate in the extending direction of the sliding pipes 33. In addition, the sliding pipes 33 may be juxtaposed in the right-left direction, and the sliding pipes 33 are supported by the supporting portion 3 so as to be slidable back and forth.

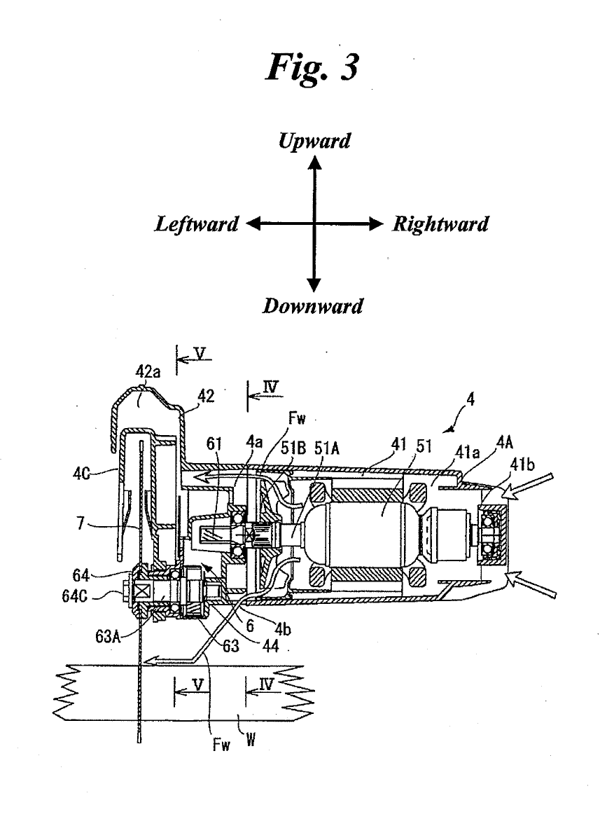

The cutting portion 4 is configured such that a housing 4A journalled to the rocking shaft portion 35A is used as an outer shell. As shown in FIG. 2, the housing 4A mainly includes a motor housing portion 41, a cutting blade housing portion 42, a handle 43 used as a grip part during cutting, and a gear case 44. As shown in FIG. 3, the motor housing portion 41 has a motor housing space 41a defined therein, and a motor 51 is built in the motor housing space 41a. In the motor housing portion 41, an air intake port 41b through which ambient air is allowed to flow into the motor housing space 41a is formed at a right end opposite to the cutting blade 7, and an introduction passage 4a which communicates with the motor housing space 41a, and also communicates with a cutting blade housing space 42a which will be described later is formed on the left on the side of the cutting blade 7.

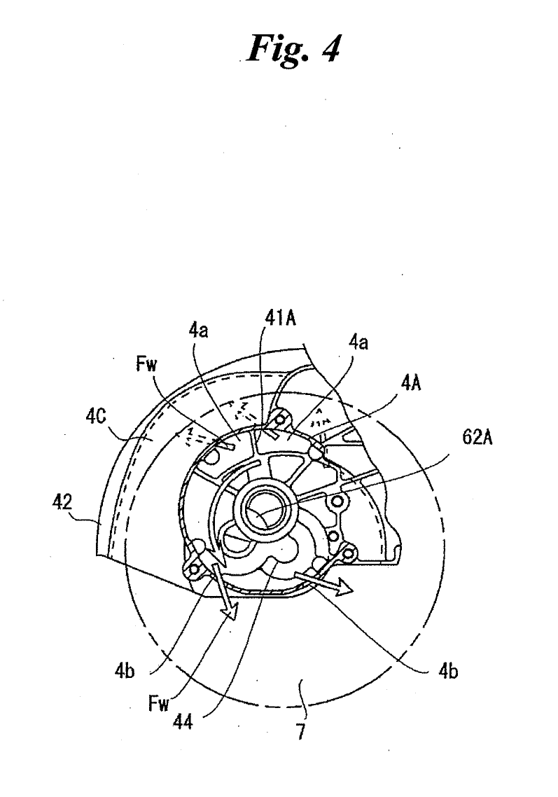

A part which forms the introduction passage 4a of the motor housing portion 41 and communicates with the cutting blade housing space 42a which will be described later, as shown in FIG. 4, is provided with ribs 41A which partition the introduction passage 4a. By providing the ribs 41A, the strength of the part which forms the introduction passage 4a of the motor housing portion 41 is kept. Additionally, an exhaust hole 4b which allows the motor housing space 41a and the ambient air to communicate with each other is formed in a position in the vicinity of the gear case 44 in the lower portion of the motor housing portion 41 which faces the timber W.

As shown in FIG. 3, the motor 51 has a rotary shaft 51A, is arranged within the motor housing space 41a and is fixed to the motor housing portion 41 so that the rotary shaft 51A becomes parallel to the rotary shaft of the cutting blade 7, and is located on the right side of the cutting blade 7. A gap through which air can be blown in the right-left direction across the motor 51 is formed between the motor 51 and the motor housing portion 41 in a state where the motor 51 is housed within the motor housing space 41a. A pinion gear 61 which constitutes a transmission mechanism 6 which will be described later is provided at the tip of the rotary shaft 51A, and a fan 51B is provided in a position which becomes a base portion of the pinion gear 61 of the rotary shaft 51A so as to be rotatable with the rotary shaft 51A. Since the fan 51B is a centrifugal fan, the air volume of the fan can be made high compared with an axial fan.

When the fan 51B rotates by driving the motor 51, vortex Fw which proceeds to the introduction passage 4a (the left of the fan 51B) from the motor housing space 41a is generated. Therefore, negative pressure is formed on the right of the fan 51B in the motor housing space 41a. Ambient air is taken in from the air intake port 41b by this pressure difference, and this ambient air circulates through the motor housing space 41a, and cools the motor 51. The ambient air which has cooled the motor 51 flows into the introduction passage 4a beyond the fan 51B.

The direction in which the vortex Fw generated by the fan 51B whirls becomes the same direction as the rotational direction of the fan 51B. Additionally, since the exhaust hole 4b is formed in the left position of the fan 51B, a portion of the vortex Fw generated by the fan 51B is blown out from the exhaust hole 41b.

The cutting blade housing portion 42 has the cutting blade housing space 42a communicating with the introduction passage 4a formed therein, and a portion of the cutting blade 7 and a protective cover 4C which protects the cutting blade 7 are configured within the cutting blade housing space 42a so as to be able to be housed. Therefore, the vortex Fw from the fan 51B which has flowed into the introduction passage 4a is guided into the cutting blade housing space 42a after being corrected by the ribs 41A (FIG. 4).

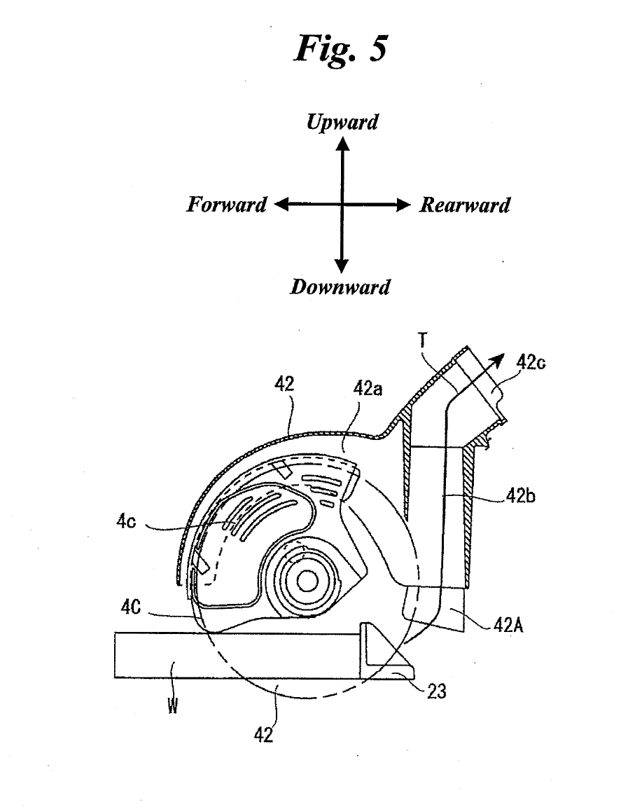

As shown in FIG. 5, a dust discharge passage 42b which extends upwards from a rear end position of the cutting blade 7 is formed behind the cutting blade housing portion 42, a dust discharge port 42c is defined at the upper end of the dust discharge passage 42b, and a garbage collection bag 8 (FIG. 1) in which dusts are stored is attached to the portion of the dust discharge port 42c. Additionally, a guide 42A which is located on the right and left sides and on the rear side with respect to the rear end position of the cutting blade 7 is provided in the position of the cutting blade housing portion 42 which becomes a lower end of the dust discharge passage 42b.

The protective cover 4C is mounted on the cutting blade housing portion 42 so as to be rotatable around the cutting blade 7 almost coaxially with the rotary shaft of the cutting blade 7. Thus, when the cutting portion 4 (FIG. 1) has rocked upwards, the protective cover covers the lower portion of the cutting blade 7, and when the cutting portion 4 has rocked downwards, the protective cover is housed within the cutting blade housing space 42a, and the lower portion of the cutting blade 7 is exposed. Additionally, a plurality of slits 4c is formed in a direction parallel to the rotational direction of the cutting blade 7 in the portion of the protective cover 4C which faces the introduction passage 4a.

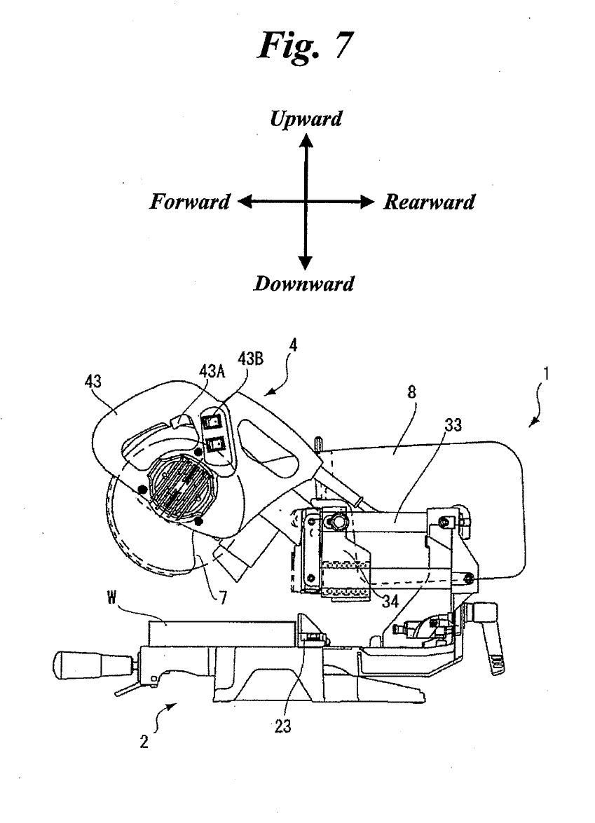

The handle 43, as shown in FIG. 2, is arranged above the motor housing portion 41, and as shown in FIG. 7, is provided with a trigger 43A which controls the rotation of the motor 51 (FIG. 3), and a power switch 43B of a laser oscillator (not shown) which irradiates a part which becomes a cut position on the timber W with a laser beam or a light which illuminates the timber W.

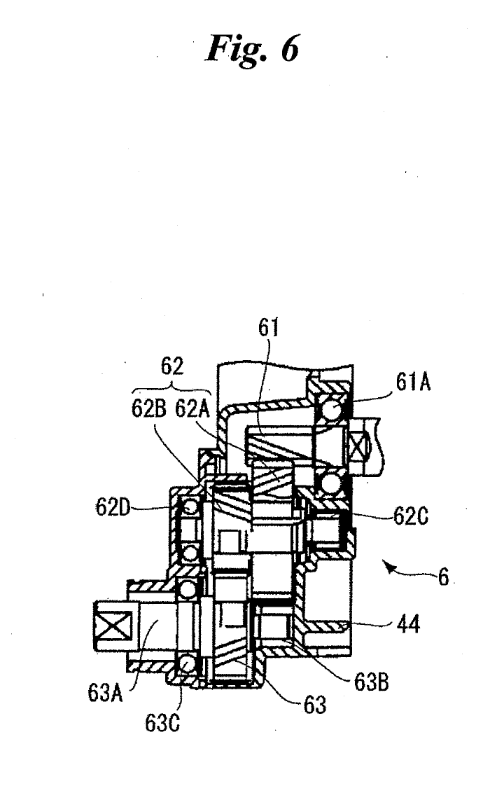

As shown in FIG. 2, the gear case 44 is located in the lower portion of the housing 4A between the motor housing portion 41 and the cutting blade housing portion 42, and as shown in FIG. 6, has a transmission mechanism 6 built therein.

The transmission mechanism 6 mainly includes the aforementioned pinion gear 61 that is a first gear, an intermediate gear 62, and a final gear 63. The aforementioned pinion gear 61 is constituted by a helical gear, and is supported on the gear case 44 by the bearing 61A. The intermediate gear 62 includes a second gear 62A which meshes with a pinion gear 61, a third gear 62B which is arranged coaxially with the second gear 62A, and meshes with the final gear 63, and is rotatably supported on the gear case 44 by a pair of bearings 62C and 62D. Additionally, the second gear 62A and the third gear 62B are constituted by helical gears, respectively, and are configured so that the respective tooth trace directions are opposite to each other, and the number of teeth of the second gear 62A becomes more than the number of teeth of the third gear 62B. By this configuration, the number of rotations of the pinion gear 61 can be reduced and transmitted to the final gear 63, and thrust directions can be configured so as to be cancelled by each other. The final gear 63, which is a helical gear, meshes with the third gear 62B, has a spindle 63A mounted with the cutting blade 7, and is rotatably supported on the gear case 44 by the pair of bearing 63B and bearing 63C.

Since the final gear 63 is decelerated by the intermediate gear 62, and its power is transmitted, it is not necessary to use a gear with too large a diameter in the pinion gear 61 to the final gear 63. Therefore, the gear case 44 around the pinion gear 61 to the final gear 63 can be made small. By making the gear case 44 small, the gear case 44 is kept from abutting on the timber W when the cutting portion 4 is tilted. Additionally, a flange 64 and a bolt 64C which fix the cutting blade 7 can be mounted on the spindle 63A.

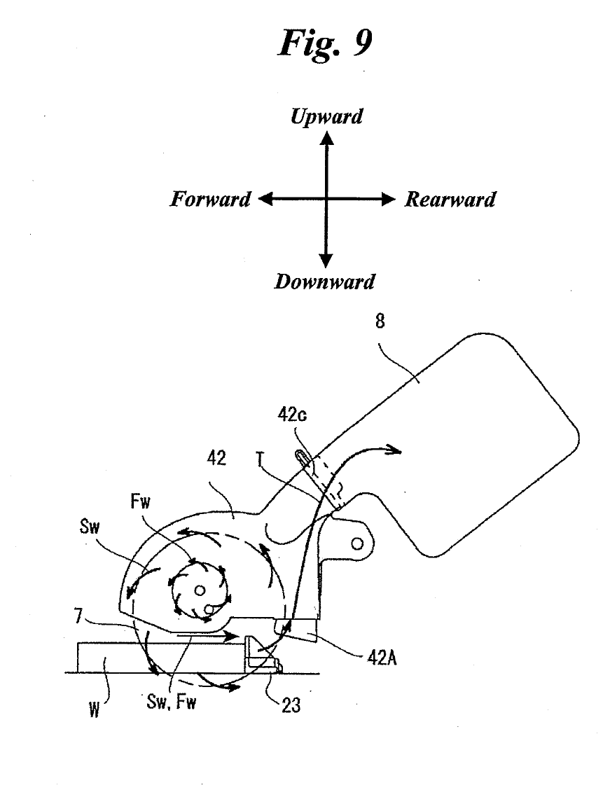

The cutting blade 7 is fixed by the flange 64 and the bolt 64C so as to be rotatable integrally and coaxially with the spindle 63A, and is arranged so that its side surface becomes parallel to sliding direction of the cutting portion 4, and is driven and rotated by the motor 51. As for the rotational direction at this time, the cutting blade rotates so that the outer periphery of the cutting blade 7 moves downward from above on the plane of the paper of FIG. 2 (clockwise on the plane of the paper of FIG. 1). As the cutting blade 7 rotates, an airflow Sw (FIG. 9) along the rotational direction of the cutting blade 7 is generated around cutting blade 7. By the airflow Sw and the reaction at the time of the cutting of the timber W, as shown by an arrow T of FIG. 5, dusts are blown away and fed towards the guide 42A, and are made to flow into a dust discharge passage 42b, and dusts are stored within the garbage collection bag 8 (FIG. 1) from the dust discharge port 42c.

Additionally, since the final gear 63 which is integral with the spindle 64A to which the cutting blade 7 is fixed is connected with the pinion gear 61 via the intermediate gear 62, the rotational direction of the final gear 63 and the rotational direction of the pinion gear 61 become the same direction. Therefore, the cutting blade 7 which rotates coaxially and integrally with the final gear 63, and the fan 51B which rotates coaxially and integrally with the pinion gear 61 rotate in the same direction. Since the rotational directions of the fan 51B and the cutting blade 7 are the same direction, and the rotary shaft of the cutting blade 7 and the rotary shaft of the fan 51B are parallel to each other, as shown in FIG. 9, the direction of the vortex Fw by the fan 51B and the direction of the airflow Sw in the cutting blade 7 coincide with each other.

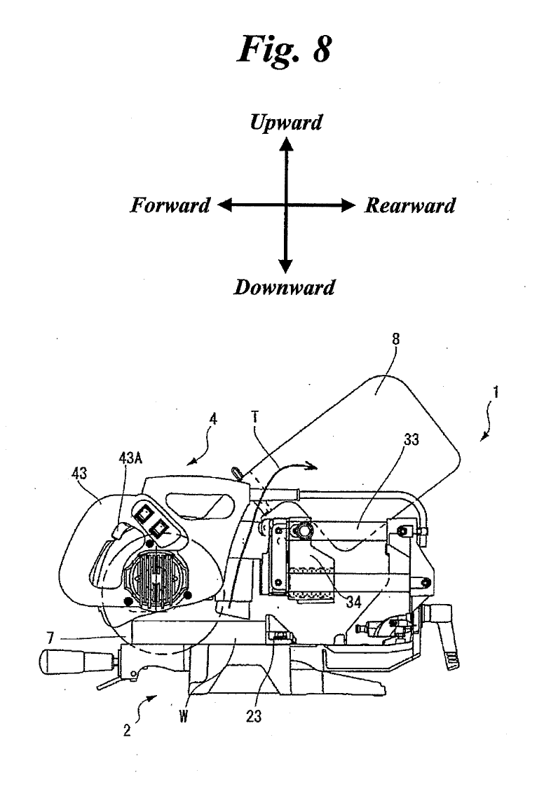

When the bench cutting machine 1 of the above configuration cuts the timber W, as shown in FIG. 7, the timber W is placed on the base portion 2, and the cutting portion 4 is made to slide on the sliding pipe 33, and is made to move to the foremost side. If the trigger 43A is pulled from this state, as shown in FIG. 8, the cutting portion 4 is rocked downward, and the cutting blade 7 is pushed against the timber W. Although the dusts of the timber W are generated at this time, as shown in FIG. 9, the dusts flow like the arrow T through the airflow Sw generated in the cutting blade 7, and are stored in the garbage collection bag 8. Additionally, although the vortex Fw generated by the fan 51B passes through the introduction passage 4a and is introduced into the cutting blade housing space 42a, since the whirling direction of the vortex Fw, and the direction of the airflow Sw are the same direction, the transfer of the dusts through the airflow Sw is not obstructed. On the contrary, the vortex Fw is added to the airflow Sw, so that dusts can be more properly transferred into the garbage collection bag 8, and the derivation efficiency of the dusts can be enhanced.

Since the airflow Sw and the vortex Fw, as shown in FIG. 9, flows towards the rear from the front on the surface of the timber W, dusts are kept from flowing towards the rear and flowing towards a user on the front of the bench cutting machine 1 around a cutting part of the timber W. Additionally, as shown in FIG. 3, although a portion of the vortex Fw is also blown out from the exhaust hole 4b, the vortex Fw blown out from the exhaust hole 4b also similarly flows towards the rear from the front on the surface of the timber W, and flows towards the cutting blade 7 from the exhaust hole 4b. Therefore, dusts which have deviated to the right from the vicinity of the cutting blade 7 are also blown away to the vicinity of the cutting blade 7 by the vortex Fw from the exhaust hole 4b, are caught by the airflow Sw which flows through the vicinity of the cutting blade 7, are transferred like the arrow T, and are stored by the garbage collection bag 8.

After the cutting portion 4 is rocked, the cutting portion 4 is made to slide on the sliding pipe 33, and is made to move back, thereby ending the cutting of the timber W. Even when the cutting portion 4 moves back, as described above, dusts are blown away rearwards by the airflow Sw and the vortex Fw in the vicinity of the cutting blade 7, and the vortex Fw which is blown out from the exhaust hole 4b, the dusts do not flow towards the user (front), and cutting work can always be performed in a comfortable environment.

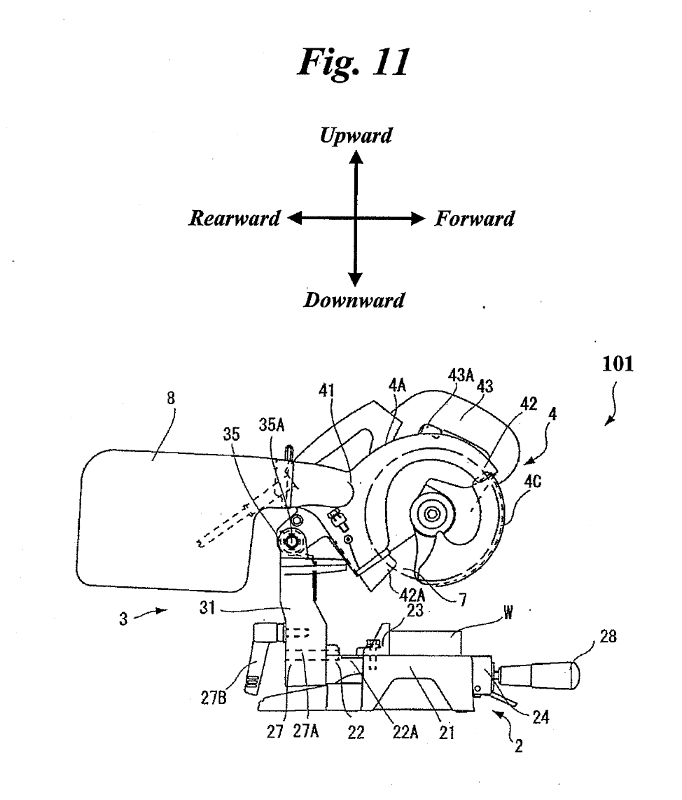

In the embodiment, the cutting blade 7 is orthogonal to the upper surface of the base portion 2. However, if the cutting portion 4 is tilted to the right and left, dusts can similarly be stored in the garbage collection bag 8. Further in the bench cutting machine 101 in which the cutting portion 4 is directly and swingably mounted on the tilting portion 31, as shown in FIG. 11, dusts can similarly be suitably stored in the garbage collection bag 8.

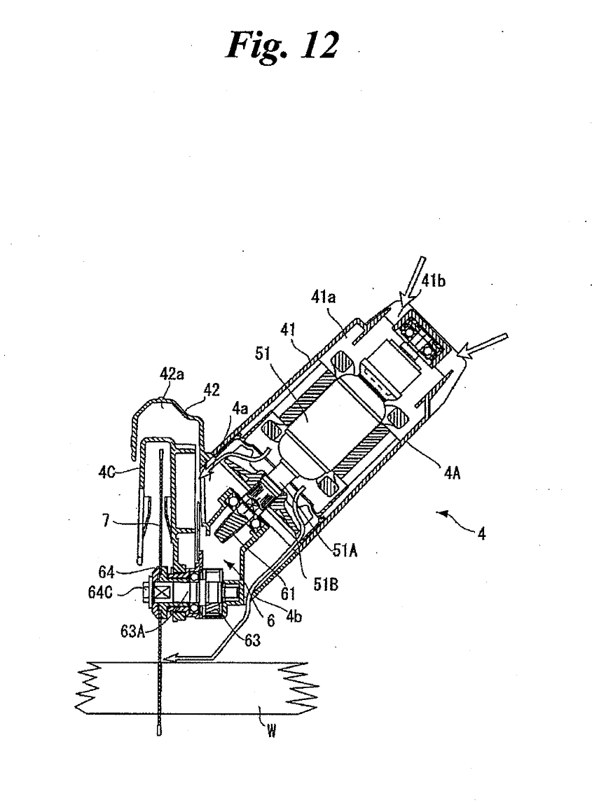

In the embodiment, the rotary shaft of the cutting blade 7 and the rotary shaft 51A of the motor 51 are made parallel to each other, as shown in FIG. 12. However, the rotary shaft of the cutting blade 7, and the rotary shaft 51A of the motor 51 may intersect each other. In this case, since the direction of the vortex Fw coincides with the rotational direction of the cutting blade 7, the airflow generated by the cutting blade 7 is not hindered by the vortex Fw.

According to an aspect of the present invention, there is provided a bench cutting machine, in which the dusts during cutting can be more suitably discharged to the outside of the machine using the fan air. Additionally, since the transmission mechanism which makes the rotational directions of the fan and the saw blade the same is provided, a plurality of gears which constitute a transmission mechanism can be small, and when the cutting portion is rocked downward, the cutting portion is prevented from abutting on a descending member, so that the depth of cut-in can be enhanced. Since the cutting portion can be prevented from abutting on a descending member even when the cutting portion is inclined, the depth of cut-in during bevel cutting can be enhanced.

This application claims priority from Japanese Patent Application No. 2008-253617 filed on Sep. 30, 2008, the entire contents of which are incorporated herein by reference.

### INDUSTRIAL APPLICABILITY

According to an aspect of the present invention, there is provide a bench cutting machine which more suitably discharges the dusts to the outside during cutting.

1. A bench cutting machine comprising:
a motor that drives a cutting blade;
a fan that is driven by the motor to generate a fan air for cooling the motor;
a base portion that supports a member to be worked;
a cutting portion that is provided on the base portion and that accommodates the cutting blade over the base portion; and
a supporting portion that is connected to the base portion and that supports the cutting portion so that a position of the cutting blade with respect to the base portion is adjustable,
wherein the motor is arranged on the lateral side of the cutting blade,
wherein the cutting portion includes:
a housing that houses the motor, the fan and a portion of the cutting blade; and
a transmission mechanism that is housed within the housing and that transmits a power of the motor to the cutting blade,
wherein the transmission mechanism is configured so that a rotational direction of the fan and a rotational direction of the cutting blade become the same, and wherein the housing includes:
a motor housing portion that houses the motor;
a cutting blade housing portion that houses the portion of the cutting blade;
a dust discharge port that communicates the cutting blade housing portion with an outside thereof; and
a passage that communicates the motor housing portion with the cutting blade housing portion so as to allow the fan air to flow into the cutting blade housing portion.

2. The bench cutting machine of claim 1,
wherein the fan is directly driven by the motor, and
wherein the transmission mechanism includes:
a first gear that is directly driven by the motor;
a final gear that rotates coaxially and integrally with the cutting blade; and
an intermediate gear that meshes with the first gear and the final gear and that transmits a rotation of the first gear to the final gear.

3. The bench cutting machine of claim 2,
wherein the intermediate gear transmits the rotation of the first gear to the final gear while decelerating.

4. The bench cutting machine of claim 1,
wherein the fan is a centrifugal fan.

5. The bench cutting machine of claim 1,
wherein a rotary shaft of the motor is arranged parallel to a rotary shaft of the cutting blade.

6. The bench cutting machine of claim 1,
wherein a rotary shaft of the motor is arranged oblique to a rotary shaft of the cutting blade.

7. The bench cutting machine of claim 1,
wherein a plurality of ribs are formed within the passage in the housing.

8. The bench cutting machine of claim 7,
wherein, in a cross-sectional plane orthogonal to a rotary shaft of the cutting blade, each rib radially extends from the rotary shaft of the cutting blade.

9. The bench cutting machine of claim 1,
wherein an air intake port is formed on the motor housing portion at a side opposite to the cutting blade housing portion.
